(19) United States
(12) Patent Application Publication
(10) Pub. No.: US 2006/0278712 A1
(43) Pub. Date: Dec. 14, 2006

(54) Method and system for data reading using raster scanning

(75) Inventor: Bryan Lee Olmstead, Eugene, OR (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/150,961

(22) Filed: Jun. 13, 2005

(51) Int. Cl. G06K 7/10

(52) U.S. Cl. 235/462.32

(57) ABSTRACT

The present disclosure provides a method of scanning barcodes located on any side of a product and in any orientation that are moving through a scan volume. The disclosure a preferred embodiment is directed to a method of reading optical symbols using a high speed raster laser beam and non-retrodirective collection optics including the steps of generating a pattern of virtual scan lines traversing a two-dimensional imaging region, the pattern of virtual scan lines having less than the entirety of said two-dimensional region; obtaining a stream of raster data over the two-dimensional imaging region; prior to storing any of the raster data, identifying a select portion of the raster data corresponding to the virtual scan lines; storing the select portion of raster data; and decoding the select portion of raster data.

### TECHNICAL FIELD

The field of the present disclosure relates to optical readers and methods of data reading, and more particularly, to methods and systems using a small number of high speed scan lines to generate a raster of an optical code.

### BACKGROUND

Conventional fixed scanners use a motor/facet wheel to scan a laser beam across a plurality of pattern mirrors in order to generate an omnidirectional scan pattern. FIG. 1 illustrates a schematic of a conventional fixed scanner 10. The scanner 10 includes a laser diode 15 generating a laser beam 17 which is directed onto a facet wheel 20. The facet wheel 20 is rotatably driven by a motor 21 at a relatively high speed, typically several thousand rpm. The facet wheel 20 scans the beam across a plurality of pattern mirrors 22 (only one pattern mirror is shown) with the scanned beam reflecting off one or more patterns mirrors to form scan lines projected through the window 24 and into the scan volume.

Return light reflecting off the barcode 5 is collected retrodirectively onto the pattern mirrors 22, the facet wheel 20 and onto a collection mirror 26 (or alternately a lens) by which it is focused onto a detector 28.

Multiple scan lines are generated forming an omnidirectional scan pattern designed to be capable of scanning a barcode passing through the scan volume in any orientation. Also important in scanning efficiency is side coverage, that is, which sides of an item can be scanned, the item being defined as a six-sided cube or six-sided rectangular box-shaped form. L-scanners have been employed to enhance item side coverage. An L-scanner, such as the Magellan® 8500 scanner manufactured by PSC Inc. of Eugene, Oreg., has two windows oriented in a generally “L” shape, one window oriented generally vertically and one window oriented generally horizontally. The Magellan® 8500 scanner has the unique capability of scanning all six sides of an item: (1) the bottom side is scanned by scan lines from the horizontal window; (2) the leading side (i.e. the left side assuming a right to left scanning direction) is scanned by scan lines from both the vertical window and the horizontal window; (3) the trailing side (i.e. the right side assuming a right to left scanning direction) is scanned by scan lines from both the vertical window and the horizontal window; (4) the front side (i.e. the side facing the vertical window) is scanned by scan lines from the vertical window; (5) the rear or checker side (the side facing opposite the vertical window) is scanned by scan lines from the horizontal window; (6) the top side (the side facing opposite the horizontal window) is scanned by scan lines from the vertical window.

FIG. 2 diagrammatically illustrates a scan pattern 30 generated through the horizontal window of a Magellan® 8500 scanner. The facet wheel of the Magellan® 8500 scanner is rotated at about 100 times per second (6000 rpm). The scan pattern is made of families (or groups) of generally parallel lines, due to the angular separation of each facet on the facet wheel. For the Magellan® 8500, there are four facets, each arranged at a different angle relative to the rotational axis, so there are four parallel lines with each scan family. There are eight different pattern mirror sets on the horizontal window, leading to 32 scan lines, as shown in the pattern 30 of FIG. 2.

The scan pattern 30 is constrained by the use of families of parallel lines. A relatively large amount of physical space is needed to create the scan pattern. As illustrated in the system 10 of FIG. 1, there is significant depth to the product to contain the pattern mirrors and facet wheel. Depending on the scan engine design, the product may be even deeper or longer to handle collection. The scan lines must emanate from a point farther out than the window, which requires the product to be wider than the window in both dimensions.

Because collection is retrodirective in the typical facet wheel scanner, the facet wheel needs to be quite large. Particularly because of the small number of facets (typically three or four), windage may also be large, causing a large power consumption of the motor/facet wheel assembly. A large facet wheel also produces a significant load on the bearings, affecting the lifetime of the motor. The optical quality of the reflective surfaces of the facet wheel is difficult to maintain, due to the high speed of rotation. In addition, care must be taken to ensure structural integrity of such a facet wheel due to the large stresses from high speed rotation.

Since the scan pattern reads barcodes by spatially covering the window to hit the product at all angles, the window must be fairly large. For scanners with a horizontal window, sapphire or other scratch-resistant surface is used to provide a surface that will last under the harsh environment of products sliding over the window. The cost of this window is quite high, being a significant cost factor in the product. In order to reduce cost, the designer may be urged to trade off window lifetime, by choosing less expensive materials that may not be as durable.

### SUMMARY

The present disclosure provides a method and system of scanning barcodes located on any side of a product and in any orientation that are moving at potentially high speeds across the scanning surface. In a preferred embodiment a raster image of the product is generated using a deflected laser beam and non retro-directive collection optics. The raster image may provide a solution that has high performance and is low cost, low profile beneath the counter, and consumes low power.

A preferred embodiment is directed to a method of high speed reading optical symbols including the steps of: generating a pattern of virtual scan lines traversing a two-dimensional imaging region, the pattern of virtual scan lines comprising less than the entirety of said two-dimensional region; obtaining a stream of raster data over the two-dimensional imaging region; prior to storing any of said raster data, identifying a select portion of the raster data corresponding to the virtual scan lines; storing the select portion of raster data; and decoding the select portion of raster data.

These and other aspects of the disclosure will become apparent from the following description, the description being used to illustrate a preferred embodiment when read in conjunction with the accompanying drawings.

### BRIEF DESCRIPTION OF THE DRAWINGS

FIG. 1 is a schematic of a scanning mechanism employing a facet wheel.

FIG. 2 illustrates a scan pattern at the horizontal window of a scanner described herein.

FIG. 3 is a schematic of scanner frame of reference for a raster scanner.

FIG. 4 is a schematic of an item frame of reference for a raster scanner.

FIG. 5 illustrates raster scans of a barcode label.

FIG. 6 diagrammatically illustrates a raster scanner having a single slot.

FIGS. 7-8 diagrammatically illustrate an L-shaped raster scanner multiple slots.

FIG. 9 diagrammatically illustrates a side elevation view of non-retrodirective collection mechanism according to a preferred embodiment.

FIG. 10 is a top view of the mechanism of FIG. 9.

FIG. 11 is a diagram of scanning resolution parameters.

FIG. 12 is a perspective view of a preferred embodiment collection lens.

FIG. 13 is a top view of the collection lens of FIG. 12.

FIG. 14 is a side view of the collection lens of FIG. 12.

FIG. 15 is a schematic of an electronic scan generator.

FIG. 16 is a schematic of an alternate electronic scan generator.

FIG. 17 is a diagram illustrating methods for scan line generation and pixel selection methods.

FIGS. 18-21 are diagrams of scan patterns of a single X pattern at four different item speeds.

FIGS. 22-25 are diagrams of scan patterns of an X pattern with additional scan lines at four different item speeds.

FIGS. 26-29 are diagrams of scan patterns illustrating scan line gaps.

FIGS. 30-32 are diagrams of scan patterns for filling scan line gaps.

FIGS. 33-36 are diagrams of dense scan patterns according to an alternate embodiment.

FIG. 37 is a schematic raster scanner with two axis rastering on one scan window.

FIG. 38 is a schematic of a scan mechanism for the scanner of FIG. 23.

FIG. 39 is a schematic of a line imaging raster scanner according to an alternate embodiment.

FIG. 40 is a schematic of a line imaging raster scanner according to an alternate embodiment employing Scheimpflug optics.

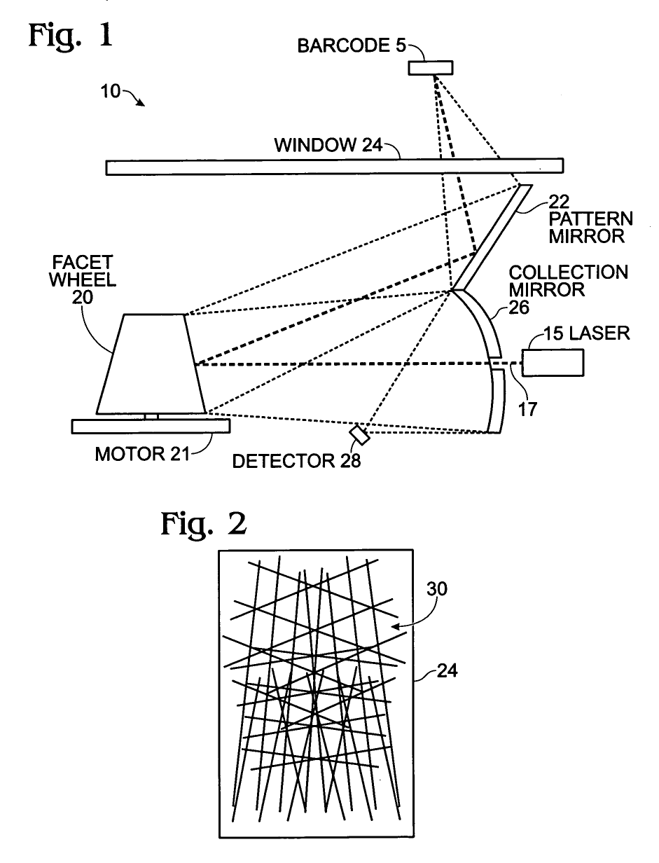

### DETAILED DESCRIPTION OF THE PREFERRED EMBODIMENTS

While certain preferred embodiments are described below with reference to a high speed raster scanning, a practitioner in the art will recognize the principles described herein are viable to other applications. Further certain preferred embodiments will be described with respect to scanning barcodes, it should be understood that the principles described herein are applicable to other types of optical codes (e.g. 1-D, 2-D, Maxicode, PDF-417) as well as imaging of other items such as fingerprints.

In a preferred configuration, a raster scanner is disposed at the scan location, such as the checkout counter of a retail establishment, and items are passed through the scan field. Instead of generating a spatial scan pattern, a raster scanner according to a preferred embodiment generates a single scan line, aimed toward the item being passed through the scan field. The scan line forms a plane through which the item is passed. This scan line has a rapid repetition rate, compared to a conventional fixed scanner. Data gathered from this scan line creates a raster image, with the “Y” direction created by the scanning operation, and the “X” direction created by the movement of the product past the scan line.

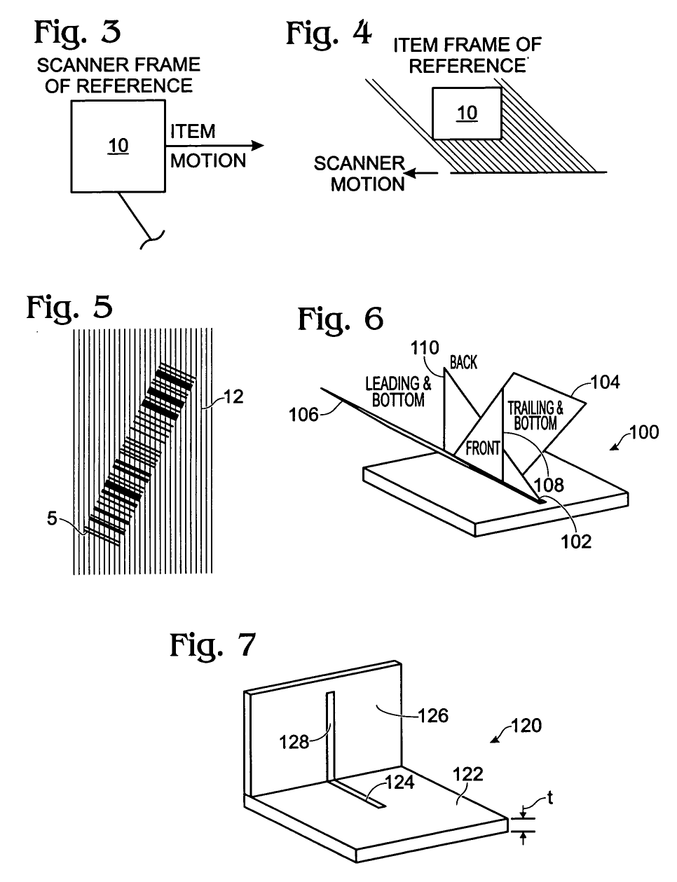

The operation is similar to a fax machine. The difference, is that the human operator moves the product past the scan line (i.e. through the scan plane), instead of a motorized belt moving the paper past the rastering mechanism of a fax machine. The irregularities in human motion of the product past the scan line will cause geometric distortions in the captured image, but as most human motion is relatively smooth, particularly at high speeds, this distortion is tolerable, as barcode information is tolerant of some distortion. It is noted that there are two different frames of reference (points of view) in optical code scanning, namely the item point of view and the scanner point of view. FIGS. 3-4 illustrate these two frames of reference. From the scanner frame of reference shown in FIG. 3, the scanner is repetitively sending out a single scan line while the product is moving past/through the plane of the scan line, thus changing the position of where the scan lines strike the product. From the item frame of reference shown in FIG. 4, the item is stationary and the barcode scanner is moving across it (in the opposite direction), providing many strikes across the product. The item frame of reference may be more helpful in understanding the scanner's operation.

Considering a product with a barcode on the bottom and using the item frame of reference from FIG. 4, the scan lines form a raster pattern 12 on the item, as shown in FIG. 5. This raster pattern 12 may be thought of as similar to how a fax machine operates. A line is scanned and converted to an intensity profile. Then the object/item is moved a certain distance and the process is repeated (i.e. another line is scanned) generating a multitude of lines resulting in a 2-D raster image. It is understood that while the extent of the image along the laser scan line is determined by the optics of the system, the other axis is of infinite extent as it is not known when a object will appear in the field of view. At a given item velocity and scan line repetition rate, a given line-to-line spacing results, defining the resolution in this axis (along with the laser spot size). At a given scan rate and the faster the item moves, the lower the resolution and the slower the item moves, the higher the resolution (until limited by the resolution due to the laser spot size).

In order to read multiple sides of an item, multiple raster patterns may be required. The three primary configurations for fixed optical code scanners are (1) a flat-top horizontal scanner; (2) a vertical scanner; and (3) an L-shaped scanner having both a horizontal component and a vertical component. Each of the configurations would preferably generate four scan lines in order to provide multi-sided reading, with the L-scanner preferably being able to read all six sides of an item.

FIG. 6 illustrates a horizontal scanner 100 having a single elongated slot 102 disposed perpendicularly to the direction of item movement through the scan volume. Were the scanner to comprise an integrated scale, the slot 102 would be disposed within the weigh platter. In this embodiment, the scanner 100 is described with respect to items being passed through the scan volume from left to right from the perspective of the operator, who is standing in front of the scanner near the front edge. The scanner 100 is provided with four scan line generators each producing a scan line directed through the slot 102: (1) a leading scan line 106 (directed diagonally up and to the left), for reading the leading right side and the bottom side; (2) a trailing scan line 104 (directed diagonally up and to the right) for reading the trailing left side and the bottom side; (3) a front scan line 108 directed diagonally up and toward the operator for scanning the front side (i.e. the side facing opposite the operator) and possibly also the bottom side; (4) a back scan line 110 directed diagonally up and away from the operator for scanning the back side (i.e. the side facing the operator) and possibly also the bottom side.

FIGS. 7-8 illustrates a L-scanner 120 including (a) a lower horizontal section 122 with an elongated slot 124 disposed perpendicular to the direction of item movement through the scan volume and (b) an upper vertical section 126 with an elongated slot 128 also disposed perpendicular to the direction of item movement through the scan volume. The lower section 122 may comprise a weigh platter of an integrated scale, whereby the slot 124 would be disposed within the weigh platter. The scanner 120 is provided with four scan line generators each producing a scan line directed through the slots 124/128: (1) a leading scan line 132 (directed through slot 124 diagonally up and to the left) for reading the leading right side and the bottom side; (2) a trailing scan line 130 (directed through slot 124 diagonally up and to the right) for reading the trailing left side and the bottom side; (3) a front scan line 134 directed through the slot 128 diagonally down and outward toward the operator for scanning the front side (i.e. the side facing opposite the operator) and possibly also the top side; (4) a back scan line 136 directed through slot 124 diagonally up and away from the operator for scanning the back side (i.e. the side facing the operator) and possibly also the bottom side. Alternately, slot 124 may extend outwardly and cover the lower section 122 to about the lower section front edge.

Alternately or in addition thereto, the trailing scan line 130 and/or the leading scan line 132 may be generated and projected out through the vertical slot 128. Such a configuration would potentially enhance front side coverage but at the expense of bottom side coverage. However, having one of the leading scan lines 132 and trailing scan lines 130 projected out the bottom slot and the other projected out the top slot 128 may produce a good compromise.

In another alternative, additional trailing and leading scan lines may be generated and projected out the vertical slot 128 in combination with scan lines 130, 132, 134, 136 to form a total of six scan lines.

This number of scan lines compares to 64 scan lines for the Magellan® 8500 for comparable product coverage. This possible since each scan line of the preferred embodiment is capable of gathering a complete 2-D image, while scan lines in a scanner, for example, the Magellan® 8500 are capable of scanning only in the direction of the scan lines.

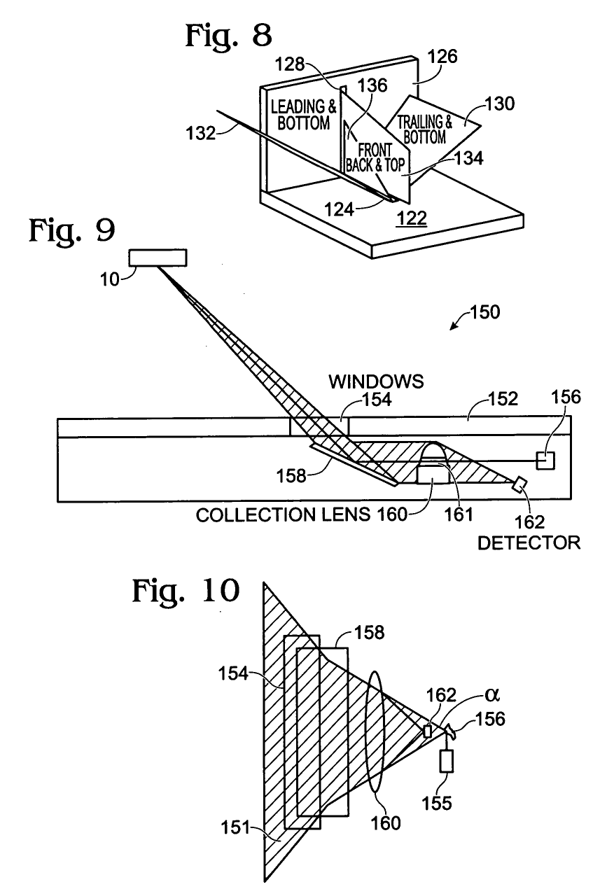

Each of the scan lines may be separately generated and collected by a scan engine. FIGS. 9-10 illustrate a non-retrodirective raster scanning system 150 according to preferred embodiment that would produce one of the scan lines of FIGS. 6-8. The system 150 includes a light source 155, such as a laser diode, generating a light beam directed to a ditherer 156. The ditherer 156 scans the light beam over an angle a through a gap 161 in the collection lens 160 and then reflecting off the redirection mirror 158 diagonally upward and through the window 154 and toward the item in the scan volume bearing the barcode. The system 150 implements a non-retrodirective collection mechanism as return light reflecting/refracting off the bar code passes through the window 154, off the redirection mirror 158 where it is collected/focused by collection lens 160 toward the detector 162. The scan plane of the scanning mechanism 152 is parallel to the platter 152, due to the redirection mirror 158, which permits construction of a very thin scanner. Because of the high scan rate required, the preferred embodiment uses a resonant dithering system to create the scan line. Due to non-retrodirective collection, the moving mirror of the dither mechanism 156 may also be very small, which is advantageous for low power and low noise operation.

As a tradeoff for the simpler and more compact optics configuration, the scan rate of the scan mechanism 152 is preferably high on the order of 10,000 scans/sec. The scan rate would correspond to a facet wheel speed of 150,000 rpm if the scan line were generated by a four-sided spinning facet wheel. This rate is high relative to a conventional facet wheel scanner, which scan on the order of 2000 to 6000 rpm. In addition, the dither mechanism may scan at 5,000 Hz, providing 2 scans per oscillation of the dither mirror, left to right, followed by right to left.

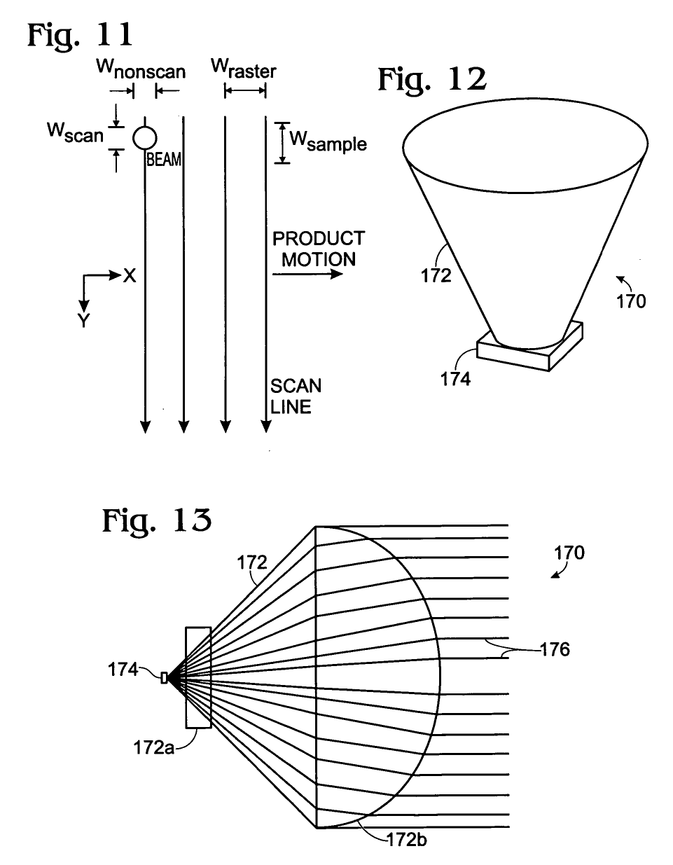

FIG. 11 illustrates the resolution of the scanner is dependent in the X axis by the scan rate, product speed, non-scanning axis spot size and in the Y axis by the analog to digital converter sampling rate, and scanning axis spot size. The elements in FIG. 11 are identified as follows:
Wₛₐₘₚₗₑ=analog to digital converter sample rate
W_{scan} and W_{nonscan}=laser spot size
Wᵣₐₛₜₑᵣ=ProductSpeed/ScanRate
dX=smaller of W_{nonscan} or Wᵣₐₛₜₑᵣ
dY=smaller of W_{scan} or Wₛₐₘₚₗₑ
   The spatial corollary to the Nyquist theorem requires that to resolve a barcode element of width dX, the sample spacing must be less than or equal to dX (which corresponds to 2 samples per spatial period). It may be desirable to have slightly better resolution than this amount, to ease the signal processing complexity, hence the oversampling ratio R given in the following equation:
   Sample Rate=Lscan·V·R²/X²
   where L_{scan}=scan line length
R=oversample ratio
X=minimum element width
V=product speed

The present inventor has recognized that an optimum tradeoff occurs when the laser spot size is uniform in the X and Y axis (i.e., a round spot shape) and the raster spacing, Wᵣₐₛₜₑᵣ, (at a given item speed) and the spatial width due to the sample rate, Wₛₐₘₚₗₑ, are on the same order as the laser spot size. At slower item speeds, the raster width will be narrower and the laser spot size will determine the resolution in the X axis. Since many of the scan lines hit the product at a 45° angle, it may be desirable to have the non-scanning axis spot size be about 70% the size of the scanning axis spot size, to compensate for the spot size growth when projected onto the item bearing the barcode.

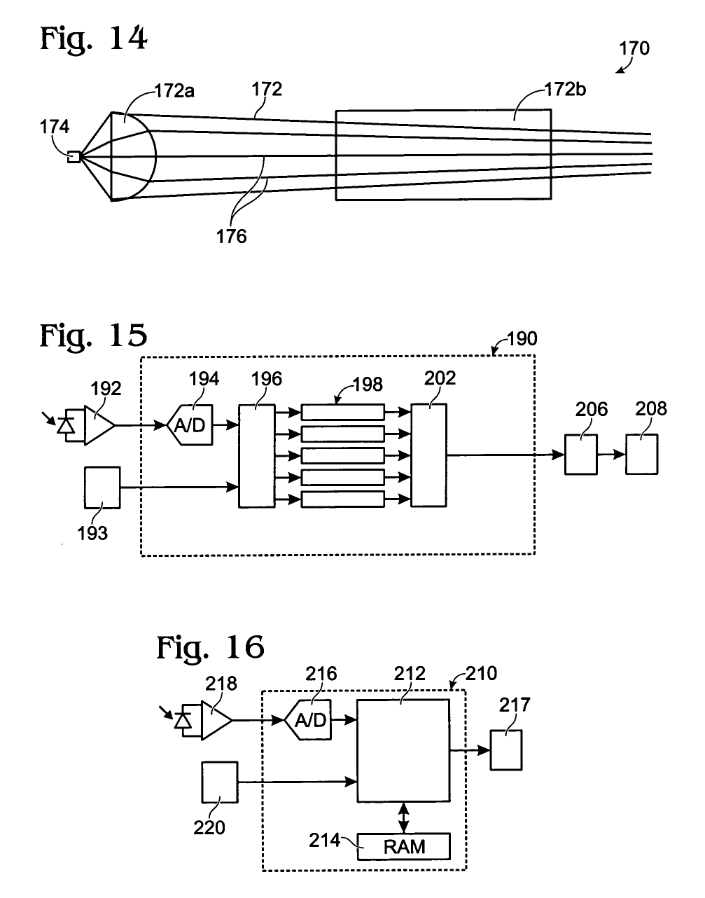

The raster scanning systems described herein may be implemented with numerous non-retrodirective collection configurations, including numerous variations for the collection lens 160 of FIG. 10. For example, FIGS. 12-14 illustrate a collection lens system 170 comprised of an array of lenses 172 used to focus an optical image onto the detector 174 at far field in the non-scanning axis and collimate the image of the detector (image at infinity) in the scanning axis. Sample ray traces 176 produced by this lens system 170 are illustrated in FIGS. 13-14.

FIG. 12 illustrate a lens 172 used for collection over a wide field of view. Typically, a compound parabolic concentrator or CPC focuses an optical image onto the detector 174, wherein the CPC is made of refractive material, including, but not limited to, optical plastic such as acrylic or polycarbonate. The array of lens 172 collects light falling within an entrance cone onto the detector 174. The lens system 170 collects light in a rotationally symmetrical manner wherein the return light may reflect from a linear path of the high speed scan line.

FIG. 13 illustrates a collection lens system 170 which may use a dielectric totally internally reflecting concentrator or DTIRC, that is a compound lens consisting of a front lens 172b and a rear lens 172a. In the scanning axis, light is collected over a wide field of view. However, the front curve of the DTIRC or front lens 172b refracts light more favorably than a CPC whereby, there is an equivalent collection between a DTIRC and CPC and a DTIRC has a reduced depth of the lens. The light internally reflects off the sides of a DTIRC as it does in the CPC. In the non-scanning axis, the light may be focused onto the detector with a conventional aspheric lens surface or rear lens 172a. Consequently, the scanning axis performs the DTIRC function and the non-scanning axis performs the focusing function. The front lens 172b focuses light in the horizontal scanning axis only across the entire scan line length toward the rear lens 172a. The rear lens 172a focuses light in the non-scanning axis to the detector 174 as illustrated in FIG. 14. The front lens 172b may be a plano-convex lens to minimize the focal length, which reduces the depth from the front of the rear lens 172a to the detector 174. The front lens 172b may be cylindrical with power to focus light in the scanning axis. The rear lens 172a may be a portion of a cylinder with a front and back radius in the scanning axis. In the non-scanning axis, the rear lens 172a may be a plano-convex asphere lens to minimize the focal length, which reduces the total required depth to the detector 174. Alternately, the front lens 172b may be made with curvature in both the scanning and non-scanning axis and the rear lens 172a may be eliminated.

Table A below compares values of the Magellan® 8500 scanner to a proposed Thin Raster Scanner, designed to read 10 mil barcodes up to 100 ips (5 mil barcodes up to 50 ips in the X axis) with a 6″ long scan line, assuming an oversample ratio of 1.0.

TABLE A

| | Magellan ® | Raster | Ratio: |
|---|---|---|---|
| Parameter | 8500 scanner | Scanner | Raster/Magellan |
| Number of Scan Lines | 64 | 4 | ⅛ |
| Repetition Rate | 100 Hz | 10 KHz | 100 |
| Scan Lines/Sec | 6,400 | 40,000 | 6.25 |
| Analog Bandwidth | 1.6 MHz | 3 MHz | 1.9 |
| Analog Channels | 2 | 4 | 2 |
| Total Bandwidth | 3.2 MHz | 12 MHz | 3.75 |

The raw data captured from a raster scanner according to a preferred embodiment would be 3.75 x the raw data from the Magellan® 8500 scanner. Much of this data is preferably thinned out before being processed, due to the electronic scan line generation mechanism, but in principle, all of this data may be used, if needed, to read the barcode. In addition, all of the raw data from the raster scanner is from an image that is gathered of the moving object so that data may be correlated spatially.

In principle, any “virtual” scan pattern could be generated from the raw data captured by the raster scan mechanism. FIG. 15 illustrates one embodiment of an electronic scan generator 190. There may be one generator 190 for each analog channel in a scanner such as four in the example from Table A. The signal from a detector is pre-amplified by pre-amp 192 and passed to an analog/digital converter 194 which digitizes the signals, forming pixels and then passes to a processor 196. The processor 196 is a pixel picker which chooses pixels along predetermined virtual scan lines. The processor 196 the values of counters that are incremented by the A/D clock (for the Y axis from FIG. 11) as coordinates for the digitized pixels and the high speed ditherer 193 period clock (for the X axis from FIG. 11). The chosen pixels are stored in a scan line buffer for each of these virtual scan lines. The scan line buffer may be a single memory array with the processor 196 choosing the appropriate memory address within the memory array for storing the pixel data. The scan line selector 202 provides a full line of scan data for processing when the selector 202 recognizes that an entire scan line of data has been stored in a given scan line buffer 198. Also, the scan line selector 202 may provide sequential delivery of full scan line data when multiple scan lines from the buffer 198 are available. The data from the scan line selector 202 is processed scan line by scan line using an edge detector 206, which may be a digital edge detector. Element width data from the edge detector 206 is processed by a decoder 208 to yield decoded barcode data. Typically, the raw preamp signal is performed digitally after the analog to digital conversion. Alternately, the edge detector 206 may be implemented in analog hardware instead of digital hardware when required by the processing complexity and speed. As the speed and complexity of raster scanning increases, some or all of the components at 196, 198, 202, 206 and 208 may be substituted for a processor or by an application specific integrated circuit (ASIC).

FIG. 16 illustrates hardware architecture for an electronic scan pattern generator 210 in which an ASIC 212 contains the electronic scan pattern generation and signal processing functions. The signals from each detector (for example, the four detectors described above) are pre-amplified by pre-amp 218 and passed to an analog/digital converter 216 which digitizes the signals and for each “pixel” and then passes to the ASIC 212 which determines, in communication with the ditherer 220, which “virtual” scan line(s) each of these pixels belongs to. The RAM 214 may be a separate device as shown or may be incorporated into the ASIC 212. The analog to digital (A/D) hardware 216 may also be partially contained within the ASIC 212. Raw analog data is preferably stored in the scan line buffers because a much lower sample rate is required to store raw data versus binary data, thus lowering the scan rate required of the dithering system. Alternately, the virtual scan line data may be stored in a digitized raw preamp data format as the sample rate is lower than for binarized data. This accumulated data may then be processed by a suitable method such as disclosed in U.S. Pat. Nos. 5,446,271; 5,635,699; or 6,142,376, each of these patents being hereby incorporated by reference.

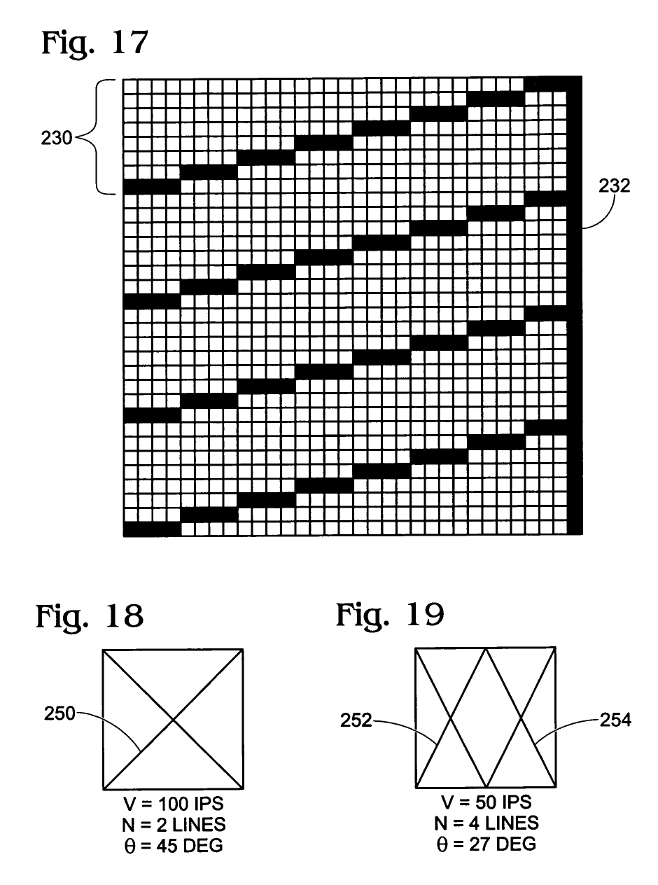

Effective scan patterns may be generated following a few very simple rules. FIG. 17 diagrammatically illustrates a set of scan lines, shown on the raster scan pattern, viewed as an image, containing pixels (digitized samples of the raw preamp data). The data digitized from the most recent raster scan line of data is depicted as column 232. The columns to the left of 232 are from previous raster scans of the object. The scan line 230 may be formed by storing a single pixel from each raster line and then advancing the row of the raw data column 232 to store by one pixel every 4 raster columns. To make the entire scan line family, a total of four scan line buffers would be used, with the pixel picking module storing a total of four equally spaced pixels, one into the four scan line buffers, offsetting the starting point every four lines. There are 32 pixels in the scan line column, in this example, and only four pixels are stored, making the output data rate to the edge detector 206 only ⅛ of the A/D sample rate. In an actual system, there may be 1200 pixels/line or more (assuming a 6″ scan line with 5 mil resolution and an oversample rate of 1 x) and many more scan lines than illustrated in the figure. The reduction in data rate to the edge detector 206 is dependent on the density of the desired scan pattern.

In order to conceptualize the scan pattern generation, a shorthand drawing methodology will be used. Instead of drawing all of the pixels, with dark pixels showing the selected pixels for the scan line, lines are drawn at the appropriate angles to illustrate the orientation of the chosen pixels. The drawings of the pixel patterns look just like conventional laser scan patterns. However, it should be recognized that these lines are composed of pixels, not continuous lines and are virtual not physical. The physical scan pattern is a single raster line with item motion providing the other dimension to form an image. Since these “lines” are composed of pixels, the pixel resolution must be high enough in order for a label to be read. Thus it is possible to draw a scan line in the right orientation but having too low resolution to read a given label. Examples of low resolution cases will be addressed below.

Unlike conventional barcode scanners, the scan pattern of the raster scanner changes with, and indeed is determined by item speed. FIGS. 18-21 illustrate creation of an X-pattern onto an item being passed through the scan field for a raster scanner where the scan line is repeated at 10,000 scans/sec. In these figures, the item is being moved through the scan field from left to right.

For a product being passed through the scan field at 100 ips (V=100 ips) as shown in FIG. 18, two lines (N=2) forming a single X pattern 250 are projected on the item, the scan lines being at an angle θ=45° to the vertical. Each scan line is formed by storing a single pixel from each raster line (columns in FIG. 17) and advancing the chosen pixel location by one, either up or down depending on the diagonal orientation, for each new raster column of data.

For a product being passed through the scan field at 50 ips (V=50 ips) as shown in FIG. 19, the X pattern 250 becomes compressed by a factor of 2 in the X axis. In the same time period as FIG. 18, the X pattern may repeat twice, yielding four lines (N=4) denoted 252 and 254. While the angle of the scan lines in the captured image remains at 45°, the slower item motion results in the angle of the X pattern if projected on the item becoming θ=27° to the vertical.

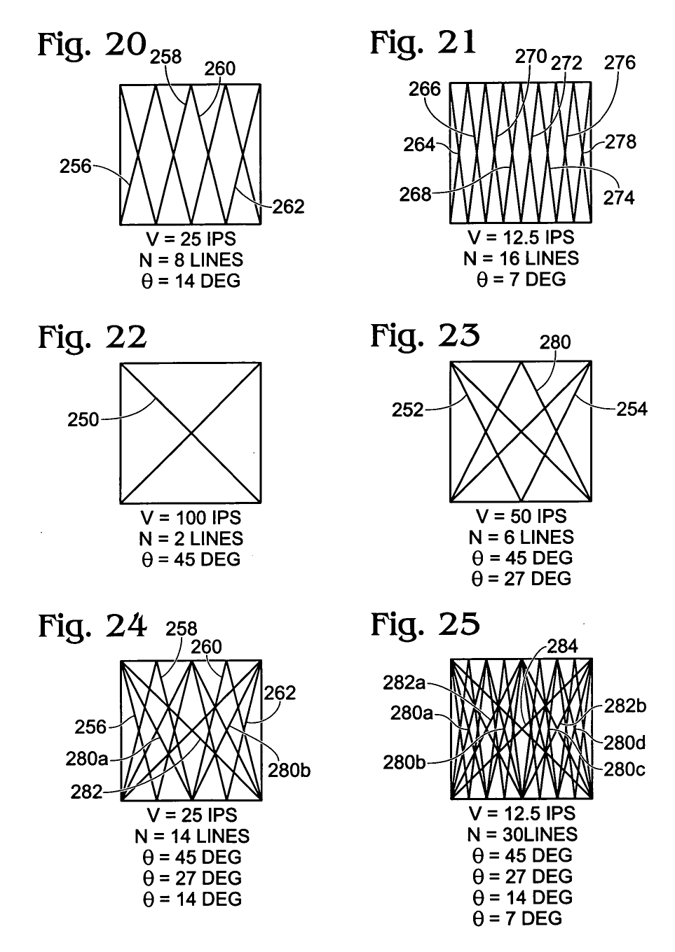

For a product being passed through the scan field at 25 ips (V=25 ips) as shown in FIG. 20, the X becomes compressed by a factor of 4 in the X axis. In the same time period, eight lines (N=8) forming four X patterns 256, 258, 260, 262 are projected on the item, the scan lines being at an angle θ=14° to the vertical.

For a product being passed through the scan field at 12.5 ips (V=12.5 ips) as shown in FIG. 21, the X becomes compressed by a factor of 8 in the X axis. Sixteen lines (N=16) forming eight X patterns 264, 266, 268, 270, 272, 274, 276, 278 are projected on the item, the scan lines being at an angle θ=7° to the vertical.

In order for the raster scanner concept to function efficiently, the item bearing the barcode has to be moved through the scan field at a given velocity. Generally, a speed of 0.8 ips should be fast enough, but in any event, it is noted that in the typical scanner environment, the operator is moving the item through the scan field at various speeds. Thus the scanner does not know how fast the item is moving so the system must be able to handle various possible item speeds.

As illustrated in FIGS. 18-19, at lower speeds, the compression of the scan lines is more severe. At speeds higher than 100 ips, the resolution may be too poor to read 10 mil labels, however, in a similar fashion, the X pattern would become stretched out in a direction perpendicular to the direction of item movement.

In order to generate an X pattern of shallower angles at the slower item speeds, the pixel assignment module may be processed to skip scan lines. For example, to make an X pattern with a θ=45° at 50 ips item speed instead of 100 ips, a pixel is stored from every other scan line and the position incremented every other scan line. The resultant scan line has ½ the output data rate (into the edge detector 206) as the X scan pattern at 100 ips. In this fashion, extra scan lines are generated at ½ speed multiples of one another to produce X scan lines on items passing at these slower item speeds.

If eight complete sets of scan lines are created at 1, ½, ¼, ⅛, 1/16, 1/32, 1/64, 1/128 the scan line rate, the same “shape” scan pattern will be available over a 128:1 range of label speeds, such as from 0.8 ips to 100 ips. The required decoding data rate to process this family of scan lines is only two times the amount needed to handle the high speed scan line by itself, since 1+½+¼+⅛+ 1/16+ 1/32+ 1/64+ 1/128 is approximately 2.

FIGS. 22-25 illustrates the effect of this slower speed X pattern generation. The scan patterns illustrated FIGS. 22-25 include the “fast” scan patterns of FIGS. 18-21, but also include the additional family of scan lines at the ½ speed multiples thereby providing a more omnidirectional pattern on items that are passing the scan field at slower speeds. In contrast with a conventional fixed scanner whose scan pattern is constant for all product speeds, the scan line density for this raster scanner increases as the item is moved more slowly through the scan field. Thus for the same number of scan lines per sec, the raster scanner has a far better scan pattern, because of the extra orientations of scan lines present at slower scan speeds.

Referring specifically to FIG. 22, for an item being passed through the scan field at a speed V=100 ips, a single X pattern 250 of two scan lines (N=2) is projected on the item, the scan lines being at an angle θ=45° to the vertical.

Referring specifically to FIG. 23, at a speed of V=50 ips, the X pattern becomes compressed by a factor of 2 in the x-axis. Four lines forming two X patterns 252, 254 (also shown in FIG. 19) are projected on the item, the scan lines being at an angle θ=27° to the vertical; and an additional X pattern 280 whose scan lines are at an angle θ=45° to the vertical is projected on the item. The scan pattern is generated by storing pixels from every other raster line. Thus a total of six scan lines (N=6) are generated.

Referring to FIG. 24, at a speed of V=25 ips, the X pattern becomes compressed by a factor of 4 in the x-axis. Eight lines forming four X patterns 256, 258, 260, 262 (also shown in FIG. 20) are projected on the item, the scan lines being at an angle θ=14° to the vertical; the X pattern 280 (from FIG. 23) becomes compressed by a factor of 2 in the x-axis with four lines forming two X patterns 280a, 280b (at an angle θ=27° to vertical) projected on the item; and an additional X pattern 282 whose scan lines are at an angle θ=45° to the vertical is projected on the item. Thus a total of 14 scan lines (N=14) are generated.

Referring to FIG. 25, at a speed of V=12.5 ips, the X pattern becomes compressed by a factor of 8 in the X axis. Sixteen lines forming eight X patterns (for the element numerals see FIG. 21, patterns 264-278) are projected on the item, the scan lines being at an angle θ=7° to the vertical. The X patterns 280a, 280b (from FIG. 19C) become compressed by a factor of 2 in the x-axis with eight lines forming four X patterns 280a, 280b, 280c, 280d at an angle θ=14° to vertical projected on the item. The X pattern 282 (from FIG. 24) becomes compressed by a factor of 2 in the x-axis with four lines forming two X patterns 282a, 282b at an angle θ=27° to vertical projected on the item; and an additional X pattern 284 whose scan lines are at an angle θ=45° to the vertical is projected on the item. Thus a total of 30 scan lines (N=30) are generated.

Additional scan line sets may be produced for each of the other ½ speed multiples (¼ speed, 1/8, 1/16, 1/32, 1/64, 1/128) in similar fashion providing enhanced item coverage at these lower item speeds.

Though a highly omnidirectional pattern at 12.5 ips is illustrated in FIG. 19D, only a single X pattern 250 at 100 ips is illustrated in FIG. 22. Thus it may be desirable to enhance omnidirectionality at high speeds by adding extra scan lines at such speeds. For example, a pair of 27° lines may be added to the 100 ips pattern (only), which will replicate itself at 50 ips as 14°, and 7° at 25 ips, and so on. Another pair at 14° for the 100 ips pattern may also be added, if desired. Each pair of lines added at 100 ips adds heavily to the processing burden, since it is running at the maximum speed, thus it may be preferred to not make the highest speed as omnidirectional, for the sake of processing efficiency.

The scan patterns that have been described above have a hole or gap between 45° and 90°. FIGS. 26-29 illustrate this gap by showing the orientations of all the scan lines at different label speeds all on a common rotation point. FIG. 26 illustrates a scan pattern at 100 ips comprising a pair of scan lines 300 at θ=45°. FIG. 27 illustrates a scan pattern at 50 ips comprising a pair of scan lines 302 at θ=45° and a pair of scan lines 304 at θ=27°. FIG. 28 illustrates a scan pattern at 25 ips comprising of a pair of scan lines 306 at θ=45°, a pair of scan lines 308 at θ=27°, and a pair of scan lines 310 at θ=14°. FIG. 29 illustrates a scan pattern at 12.5 ips comprising of a pair of scan lines 312 at θ=45°, a pair of scan lines 314 at θ=27°, a pair of scan lines 316 at θ=14°, and a pair of scan lines 318 at θ=7°. Even at the slower speeds, such as 12.5 ips in FIG. 29, there are no scan lines between 45° and 90°.

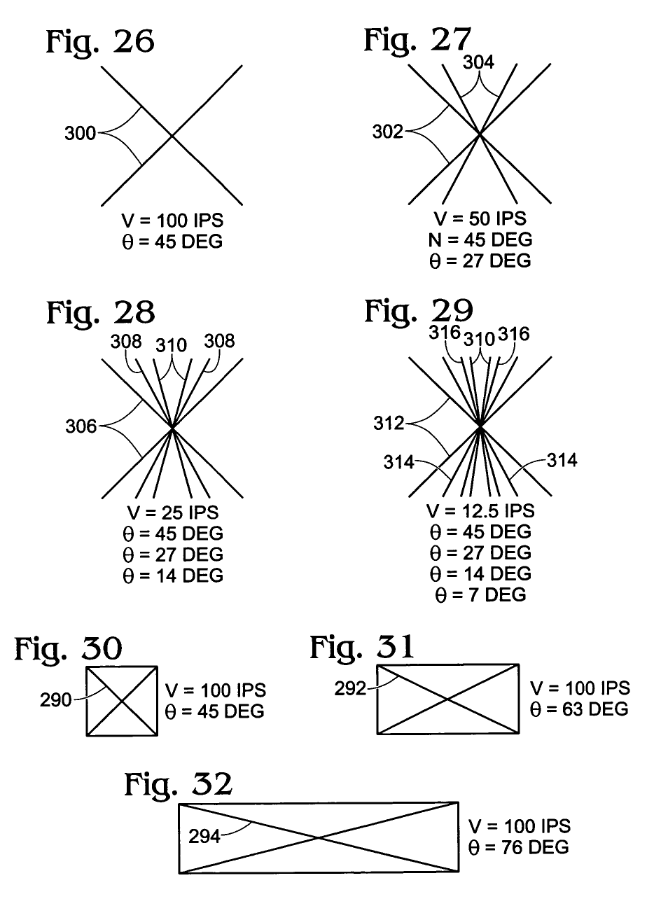

FIGS. 30-32 illustrate additional scan lines that may be created to fill these gaps. These additional scan lines are created by a slower intra-scan line advance rate than 1 per pixel. For example, in the 100 ips pattern, a pixel from two successive scan lines is taken at the same scan line “coordinate” before advancing to the next pixel position along the scan line. This advance rate may be referred to as a ½ pixel/line advance rate as opposed to the 45° scan line pair 290 shown in FIG. 30, which has a 1 pixel/line advance rate. This ½ advance rate creates a scan line pair 292 at 63° as illustrated in FIG. 31. Though this type of scan pattern requires a scan line buffer that is 2 x the length of a 45° pattern, the data processing rate is the same. Similarly, using a ¼ pixel/line advance rate yields a scan line pair 294 at 76° (as illustrated in FIG. 32) requiring a 4 x depth scan line buffer. The data processing rate for the 76° pattern is the same as for the 45° pattern.

Table B below summarizes the scan angles available with simple pixel advance rates. The pixel advance rate is the speed that the pixel assignment module advances its counter along the scan line. The line advance rate is the number of lines that are skipped before a pixel is stored. A rate of 1 means that every line is used; a rate of 2 means every other line is used. The delta angle is the angle between the previous scan angle and the current scan angle. The delta angle does not remain constant between families, but is quite small—for example, the scan pattern of the Magellan® 8500 scanner has about a 30° delta angle across its pattern. The smaller this angle, the more truncated the labels may be and yet still be readable.

TABLE B

| Pixel Advance Rate | Line Advance Rate | Scan | Delta |
|---|---|---|---|
| (Pixel/Line) | (Lines/Pixel) | Angle | Angle |
| 1/16 | 1 | 86° | 8° |
| ⅛ | 1 | 83° | 3° |
| ¼ | 1 | 76° | 7° |
| ½ | 1 | 63° | 13° |
| 1 | 1 | 45° | 18° |
| 1 | 2 | 27° | 18° |
| 1 | 4 | 14° | 13° |
| 1 | 8 | 7.1° | 7.1° |
| 1 | 16 | 3.6° | 3.5° |

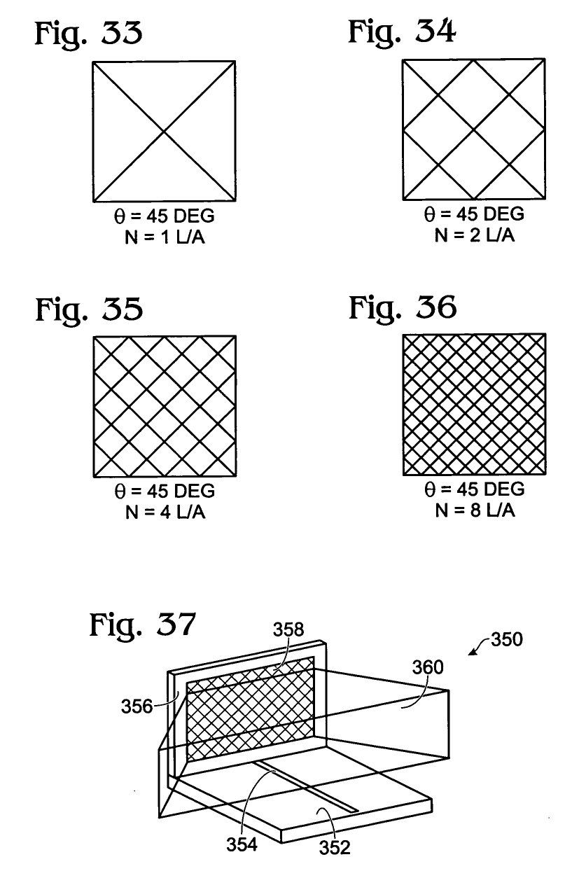

In addition to having enough rotational coverage of the scan pattern, the pattern may require spatial coverage. Multiple parallel scan lines may be generated by offsetting the starting pixel by a constant amount from the previous scan line. FIGS. 33-36 illustrates a set of increasingly dense scan patterns created by this method. The combination of this increased density method with the previous method of generating different scan angles produces a dense omnidirectional pattern. Increasing the number of scan lines/angle directly increases the processing load.

To implement these scan pattern types, a preferred configuration for a pixel picking module implemented in a processor would include:
Two raster line memories where the digitized pixel data from the A/D converter for a single raster line is stored, wherein one memory is used to store the incoming raster line, while the other memory is used to retrieve chosen pixels from the previously stored line, whereby the memories alternate in function on each raster line in a manner known in the art as double buffering.
A scan line memory with sufficient size that is capable of storing all of the chosen pixels for all of the scan lines in a given scan pattern.
A list of data representing the desired scan pattern including, but not limited to, for each scan line the starting Y pixel coordinate on the first raster column of data and the increment rate to determine the angle of the scan line.
A set of values that keep track of the next pixel that is to be stored for each scan line.
A software program that includes, but is not limited to, for each new raster line stored in the raster line memory, loops through all of the scan lines, choosing pixels at the designated coordinates, storing the chosen pixels in the appropriate scan pattern memory and incrementing the designated coordinates by the increment rate.

Following is an example of a preferred embodiment of the raster scanner. Typically, the scanner raster contains four raster mechanisms, such as in FIG. 8. Each dithering device 156 (FIG. 9) is operating at 5 KHz or 10,000 scans/sec. For an object moving past the scanner at 100 inches/sec, the spacing between raster lines is about 10 mils. The scan lines are each 6 inches long as they approach the associated window of the scanner. By sampling at 1000 samples per scan line or 10 MHz there is a sample resolution of 6 mils. In order to match the performance of a conventional laser scanner, for example the Magellan® 8500, the scan pattern from each raster line will contain three sets of scan angles: 14°, 45°, and 76° with +/− orientations, totaling 6 orientations spaced about 30° apart.

There are four parallel lines at each scan angle providing 24 virtual scan lines that are formed from each raster line generated by the scanner that is described in this disclosure. There are four raster lines in the scanner. Therefore, a total of 96 virtual scan lines are generated by the scanner.

To cover varying item speeds, slower data rate virtual scan lines are generated at 1/2, 1/4, 1/8, 1/16, 1/32, 1/64 and 1/128 the raster line rate. The raster line rate provides eight times the total number of scan lines or 768 scan lines. The data rate to the edge detectors is 2 x the data rate of the original 96 scan lines because of the reduced data rate of the additional scan lines. The number of samples in each of the 14° and 45° scan lines is 1000 samples, which is the same as the digitized width of the raster line. The number of samples in the 76° scan lines is 2000 samples as shown in FIG. 32. The total number of stored samples for the whole scanner may be calculated by (4 sources)×(four parallel lines)×(2 orientations) x (1000 samples/14°+1000 samples/45°+2000 samples/76°)×8 speeds which is equal to about 1 million samples. If two bytes are stored per sample, then the 1 million samples are 2 Mb of memory. Consequently, dynamic random access memory or DRAM is appropriate as the data is refreshed at a rapid rate. Furthermore, the average number of pixels that are chosen from each raster line is 48 out of a possible 1000 pixels or about 5%. While the sample rate of each raster line is 10 MHz, the pixel rate of data going into the virtual scan line memories and to the edge detector is 480 KHz. Considering the four raster lines that make up the scanner, then about 2 million pixels/second may be processed by the edge detector. This corresponds to an equivalent analog bandwidth of 1 MHz when there is analog based edge detection.

As shown in FIGS. 22-25, the scan pattern becomes denser at slower sweep speeds, which improves the ability to read truncated labels over a scanner such as the Magellan® 8500. Table C summarizes the design parameters of the preferred embodiment as described in this disclosure. Those skilled in the art may recognize that the cost of memory and processing power continue to decrease, enabling improved performance by a raster scanner by increasing the number of virtual scan lines and/or increasing the raster seep speed.

The scan pattern provides a fairly constant 30° spacing at the fastest speed. At slower speeds, the angular coverage becomes increasingly more dense and the spacing of lines closer together in the direction of travel. While the spacing effect happens on a facet wheel scanner, there is no angular coverage effect for the raster scanner yielding improved performance.

In order to handle a wide range of product speeds, 7 copies of the high speed lines (for a total of 8) are processed/generated at every scan angle. The total number of scan lines generated are shown in the Table C below. A 6″ pattern with 5 mil resolution would produce 1200 words/scan line for all lines except the 76° pattern, which requires 2400 words. Since ⅓ of the orientations are at 2400 words/scan line and ⅔ of the orientations are at 1200 words/scan line, the average is 1600 words/scan line. The A/D converter will probably be no more than 12 bits, requiring 2 bytes/word. The total memory needed for the scan line buffers is thus 2.4 Mb, as shown in the table below. The decoder data rate takes into account the pixel sample rate and the relative data rates of the different scan lines. The total scan rate for this scanner is 1200 scan lines per second of processed data. In contrast, the Magellan® 8500 scanner has a rate of 6400 scan lines per sec. Thus the raster scanner should have competitive performance to the Magellan® 8500 scanner despite the raster scanner's lower scan rate. Raster scanner performance may be further improved by increasing the angular and spatial coverage, at the expense of processing power required.

TABLE C

| Scan Line Type | Quantity |
|---|---|
| Spatial Coverage | 4 |
| Angular Coverage | 6 |
| Velocity Coverage | 8 |
| Number of Sources | 4 |
| Total Lines | 768 |
| Words/Scan Line | 1000 or 2000 |
| Bytes/Word | 2 |
| Total Words | 2.0 Mb |
| Scan Rate | 10 KHz |
| Pixel Rate | 12 MHz |
| Scan Lines/sec | 1200 |

The design of the A/D converter may be an important factor to cost effectiveness of a raster scanner design. The raw data coming from the pre-amp will require probably 12 bits of resolution. The bandwidth in the example on Table A requires an analog bandwidth of 3 MHz. Assuming an oversample ratio of 1.0, the sample rate is 6 million samples per second (MSPS) for the A/D converter. With clever design, the A/D for this application may be simplified. The global dynamic range is wide, but the dynamic range of the barcode itself is quite low, perhaps only 6 bits. If a ranging converter were used (gear shift / gain control concept) then a slow, coarse A/D can select the gain and a fast, coarse A/D can digitize the barcode data itself. The full 12 bit data would be recorded inside the ASIC. Much of the A/D functionality may reside inside the ASIC itself, such as for example in the form of a modified sigma-delta converter, lowering cost further by utilizing the silicon already purchased for the ASIC.

It is probably most economical to use a single ASIC to process all of the data from the different scan planes. Preferably there would be one dither/laser/collection/preamp system per scan plane. The analog preamp data would be fed to a set of A/D converters (or a multi-channel converter with sufficient speed). A single ASIC may be configured to handle all of these channels in parallel.

Current DRAM prices are low. Retail cost of a 64 MB SDRAM is $9.99, which is a much larger memory than needed. As for the ASIC, assuming the scratch registers for each scan line (X, Y, dX, dY, BufferPtr) are kept in external SRAM (roughly 8 kb required), the ASIC would act as a fast state machine, comparing its current count to the register list and transferring data to the SRAM scan line buffers. It is speculated that the ASIC should be simpler than the DAT3 chip, since the DAT3 has considerable on-board RAM, compared to this device. The state machine of the ASIC should be simpler than implementing the DAT3 instruction set. The pin count of the ASIC may be higher, however, to support the RAM bus and A/D inputs. The price for the DAT3 is less than $3, so this is a very rough estimate for the cost of this ASIC. A larger consideration then is the A/D converter. Assuming some of the functionality is contained within the ASIC, the cost for a 4 channel system should be less than $4. So, it is extremely plausible to create the electronic scan pattern module for less than $20 at current pricing levels.

Though there are some additional components, the raster scanner may eliminate many components that are in a conventional facet wheel scanner. Table D below shows the estimated cost difference between a Magellan® 8500 scanner and the raster scanner. The sapphire window cost for the raster scanner assumes a 6″×0.5″ window vs. a 6″×4″ window in the Magellan® 8500, an 8 x area reduction. At current price levels, it is estimated that nearly $80 in material costs may be saved from the $360 Magellan® 8500, over 20% of the material costs of the scanner.

TABLE D

| | Magellan ® | | Thin |
|---|---|---|---|
| Part | 8500 | Part | Scanner |
| Motor/Facet | $25 | Lasers | $16 |
| Wheel | | (4) @ $4 | |
| Pattern Mirrors | $27 | Ditherers (4) | $16 |
| | | @ $4 | |
| Sapphire Window | $61 | Small Sapphire | $8 |
| Chassis | $23 | A/D & ASIC | $20 |
| Collection Mirror | $8 | Collection | $8 |
| | | Lenses | |
| Total Savings | $144 | Total | $68 |
| | | Additions | |
| | | Net Savings | $76 |

The raster scanner relies on item motion to generate the scan pattern. If an item does not scan and the user holds the label stationary in front of the scanner, the raster scanner cannot read a label unless the barcode is oriented such that a raster scan line (or a plurality of raster scan lines if stitching is employed) traverses the entire barcode. It may be advantageous to use a simple scan pattern generation mechanism such as the previously described dither scan mechanism. However, any suitable scanning system is useable including, but not limited to, a moving spot laser, a linear imaging reader, a 1-D charge coupled device (CCD) imaging array or a 2-D CCD imaging array.

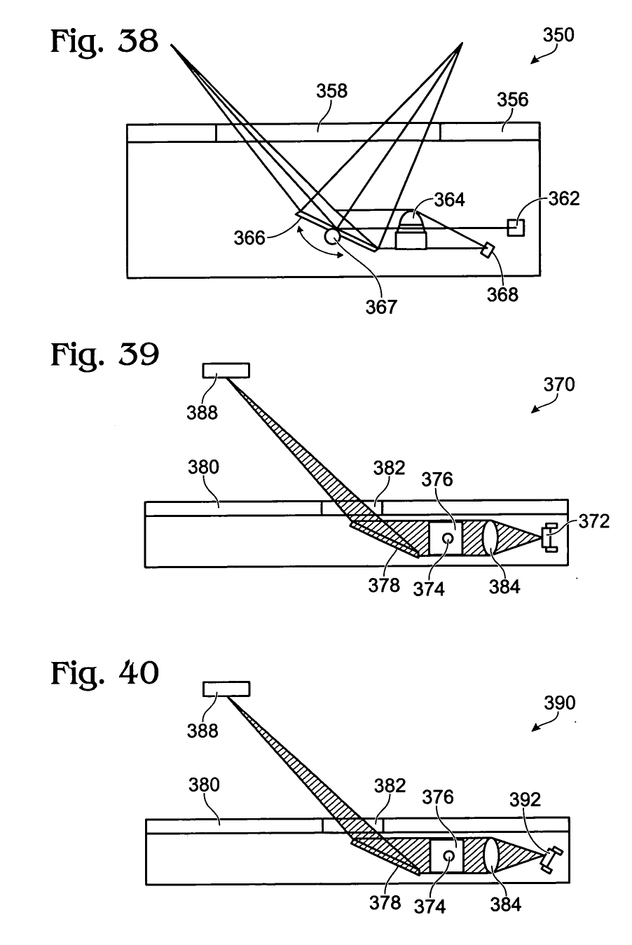

FIGS. 37-38 illustrate an alternate raster scanner 350 having an L-shape configuration with a lower horizontal section 352 and an upper vertical section 356. The lower section 352 includes a narrow slot horizontal window 354, but the upper section includes a large rectangular vertical window 358. Since items are not dragged across the vertical window 358, its material may comprise standard glass (rather than the more expensive sapphire or other scratch-resistant surface of the horizontal window 354). The system 350 includes a light source (not shown) such as a laser diode, generating a light beam directed to a ditherer 362. The ditherer 362 scans the light beam over an angle through the collection lens 364 and then reflecting off the mirror 366 diagonally through the window 358 and toward the item in the scan volume bearing the barcode. The system 350 is retrodirective with respect to the mirror 366, and non-retrodirective with respect to the ditherer 362 as return light reflecting/refracting off the bar code passes through the window 358, off the mirror 366 where the return light is collected/focused by collection lens 364 toward the detector 368. The scan plane of the scanning mechanism 362 is parallel to the window 358, which permits construction of a thin scanner.

In order to enhance reading of items presented (not moved) the mirror 366 is mounted to a motor 367 to produce a second slow moving dithering system which swings the raster scan line back and forth across the vertical window 358. The vertical head 356 may need to be somewhat deeper to accommodate this additional ditherer mechanism. The slow speed of the dithering system should not interfere with sweep scanning, but would allow labels to be read that are not moving.

Since the raster scanner captures a 2-D raster image from multiple planes, it is quite possible to read PDF-417 and true 2-D barcodes, such as Maxi-Code. The data may be stored as a rolling 2-D image and processed with techniques common for 2-D imaging scanners. Though the processing burden would be significant at fixed scanner speeds, a presentation scanner or slow sweep scanner would be quite feasible by sub-sampling the scan lines.

The raster scanner concept naturally lends itself to single line imaging techniques. The use of imaging in a fixed scanner has been problematic because of getting enough light on the target and achieving enough depth of field. These problems are managed with this concept because illumination is only necessary along the few (typically 4) scan lines, instead of requiring a 2-D field to be illuminated. A linear imager has better sensitivity than a 2-D sensor, because of increased pixel size and rectangular pixel geometry. FIG. 39 illustrates a scanner 370 having a linear imager 372. A light source 374 (e.g. LEDs or a laser source forming a laser line) projects a light beam along the same optical path as the imager 372 by use of a beam splitter 376. The lens focal length and position of linear imager 372 determines the depth of field and scan line length. The light beam from the light source 374 reflects off the mirror 378 diagonally through the window 382 in the scanner housing 380 and toward the item in the scan volume bearing the barcode 388. Return light reflecting/refracting off the bar code passes through the window 382, off the mirror 378, passing through the beam splitter 386 where it is collected/focused by collection lens 384 toward the detector 372.

Further reductions in illumination and increases in depth of field may Be achieved by using an optical configuration using the Scheimpflug technique. For example, the scanner 390 illustrated in FIG. 40 uses a 2-D imager 392 as a single line scanner. Each of the other elements in the figure are the same as the embodiment of FIG. 39 and bear the same numbers. The focal plane of the imager 392 is tilted in order to have different rows focus at different target distances. The lens aperture can be wider, since each row needs to cover a smaller depth of field. The aggregate of all of the rows of the imager 392 provides the required depth of field. Inexpensive CMOS imagers may be used, since this technique does not require a frame shutter as do other 2-D imaging techniques. In order to reduce the data rate coming out of the imager, it is preferred to locate which row or rows have data and selectively scan/

While there has been illustrated and described a disclosure with reference to certain embodiments, it will be appreciated that numerous changes and modifications are likely to occur to those skilled in the art. It is intended in the appended claims to cover all those changes and modifications that fall within the spirit and scope of this disclosure and should, therefore, be determined only by the following claims and their equivalents.

What is claimed is:

1. A method of data reading comprising the steps of:
generating a pattern of virtual scan lines traversing a two-dimensional imaging region, said pattern of virtual scan lines comprising less than the entirety of said two-dimensional region, obtaining a stream of raster data over said two-dimensional imaging region;
prior to storing any of said raster data, identifying a select portion of said raster data corresponding to said virtual scan lines;
storing said select portion of raster data; and
decoding said select portion of raster data.

2. The method as claimed in claim 1, wherein said optical symbol comprises a bar code label.

3. The method as claimed in claim 1, wherein said raster data comprises light intensity data.

4. The method as claimed in claim 1, further comprising the step of storing said select portion of raster data in an intermediate buffer prior to said step of storing said select portion of raster data in memory but after identifying said select portion of said raster data corresponding to said virtual scan lines.

5. The method as claimed in claim 1, wherein said pattern of virtual scan lines is generated according to dimensions of an optical symbol to be read.

6. The method as claimed in claim 1, wherein said step of storing said select portion of raster data further comprises the step of storing said select portion of raster data in an array of memory areas, wherein each of said memory areas is associated with a particular virtual scan line.

7. The method as claimed in claim 1, wherein the step of decoding said select portion of raster data comprises interpolating said select portion of raster data to sub-pixel resolution.

8. The method as claimed in claim 1, further comprising the step of optimizing generation of said first, second and third pattern of virtual scan lines by translating selected virtual scan lines slightly to vary points in common with other virtual scan lines.

9. The method as claimed in claim 1, further comprising the step of optimizing generation of said first, second and third pattern of virtual scan lines by replacing selected single scan lines with two shorter virtual scan lines.

10. The method as claimed in claim 1, wherein said step of obtaining a stream of raster data comprises scanning said raster data at a plurality of speeds.

11. A data reading system comprising:
generating a second pattern of virtual scan lines traversing a one-dimensional imaging region, said pattern of virtual scan lines comprising less than the entirety of said one-dimensional region, obtaining a second stream of raster data over said one-dimensional imaging region;
prior to storing any of said raster data, identifying a select portion of said raster data corresponding to said virtual san lines;
storing said select portion of raster data; and
decoding said select portion of raster data.

12. The method as claimed in claim 11, wherein said optical symbol comprises a bar code label.

13. The method as claimed in claim 11, wherein said raster data comprises light intensity data.

14. The method as claimed in claim 11, further comprising the step of storing said select portion of raster data in an intermediate buffer prior to said step of storing said select portion of raster data in memory but after identifying said select portion of said raster data corresponding to said virtual scan lines.

15. The method as claimed in claim 11, wherein said pattern of virtual scan lines is generated according to dimensions of an optical symbol to be read.

16. The method as claimed in claim 11, wherein said step of storing said select portion of raster data further comprises the step of storing said select portion of raster data in an array of memory areas, wherein each of said memory areas are associated with a particular virtual scan line.

17. The method as claimed in claim 11, wherein the step of decoding said select portion of raster data comprises interpolating said select portion of raster data to sub-pixel resolution.

18. The method as claimed in claim 11, further comprising the step of optimizing generation of said first, second and third pattern of virtual scan lines by translating selected virtual scan lines slightly to vary points in common with other virtual scan lines.

19. The method as claimed in claim 11, further comprising the step of optimizing the generation of said first, second and third pattern of virtual scan lines by replacing selected single scan lines with two shorter virtual scan lines.

20. The method as claimed in claim 11, wherein said step of obtaining a stream of raster data comprises scanning said raster data at a plurality of speeds.

21. A method of data reading comprising the steps of:
passing an item in a sweep direction through a scan volume;
scanning a reading beam at high speed and passing said scanned reading beam in a scan plane out through a slot in a data reader housing and into said scan volume, wherein said scan plane is disposed generally perpendicular to said sweep direction;
generating a raster pattern using a combination of (1) said scanned beam and (2) movement of said item passing through said scan plane;
prior to storing any of said raster data, identifying a select portion of said raster data corresponding to said virtual scan lines;
storing said select portion o said raster data; and
decoding said select portion of said raster data.

22. A method according to claim 21 further comprising collecting return light of said reading beam reflecting off an item in said scan volume non-retrodirectively.

23. A data system comprising:
a) a housing having a lower housing section and an upper housing section joined at proximate ends forming a generally L-shaped structure defining a scan volume therebetween, said lower housing section having a generally horizontal surface and the upper housing section having a generally vertical surface;
b) a first slot disposed in said horizontal surface of said lower housing section;
c) a second slot disposed in said vertical surface of said lower housing section;
d) a first scan mechanism for projecting a high speed scan line out through said first slot and into said scan volume; and
e) a second scan mechanism for projecting a high speed scan line out through said second slot and into said scan volume.

24. The data reading system according to claim 22 further comprising multiple scan planes out of said first and second slot.

25. A data reading system comprising:
a) a housing having a first housing section with a first surface facing a scan volume;
b) a first slot disposed in said first surface of said first housing section;
c) a first scan mechanism for projecting a first high speed scan line out through said first slot and into said scan volume in a plane generally perpendicular to a sweep direction of an item being passed through said scan volume; and
d) a second scan mechanism for projecting a second high speed scan line out through said slot and into said scan volume slanted from said perpendicular plane.
